(19) United States
(12) Patent Application Publication
(10) Pub. No.: US 2017/0329793 A1
(43) Pub. Date: Nov. 16, 2017

(54) DYNAMIC CONTACT SUGGESTIONS BASED ON CONTEXTUAL RELEVANCE

(71) Applicant: Microsoft Technology Licensing, LLC, Redmond, WA (US)

(72) Inventors: Elizabeth Brooks Dolman, Cambridge, MA (US); Jade Kessler, Cambridge, MA (US)

(21) Appl. No.: 15/283,926

(22) Filed: Oct. 3, 2016

Related U.S. Application Data
(60) Provisional application No. 62/336,254, filed on May 13, 2016.

(51) Int. Cl. G06F 17/30; H04M 1/2745

(52) U.S. Cl. CPC G06F 17/3097; H04M 1/274533; G06F 17/3053; H04M 1/274516

(57) ABSTRACT

Aspects of the present disclosure relate to systems and methods for providing contact suggestions. In one aspect, rendering of a file created with an application in a user interface may be initiated. The file may include at least one collaboration feature. In response to receiving an indication of interest made with respect to the at least one collaboration feature, a plurality of contacts and an associated relevancy score for each of the plurality of contacts may be received. The plurality of contacts may be sorted by the associated relevancy score for each of the plurality of contacts. At least some of the plurality of contacts may be displayed within a picker displayed on the user interface based on the associated relevancy score.

### CROSS-REFERENCE TO RELATED APPLICATION(S)

This application is a Non-Provisional patent application of, and claims priority to, U.S. Provisional Patent Application No. 62/336,254, filed May 13, 2016, entitled “DYNAMIC CONTACT SUGGESTIONS BASED ON CONTEXTUAL RELEVANCE,” which application is incorporated herein by reference in its entirety.

### BACKGROUND

Computer and software users have grown accustomed to user-friendly software applications for co-authoring files, documents, messages, and the like. For example, storage providers (e.g., cloud storage providers) provide applications such as word processing applications, spreadsheet applications, electronic slide presentation applications, email applications, chat applications, voice applications, and the like, where users can co-author and collaborate with one another within the applications. Collaboration includes identifying collaborators/users for sharing documents and/or utilizing other collaboration features. Current techniques for identifying other users to collaborate with requires typing in the name of other potential users and selecting their name when they have been suggested and identified. As such, identifying users for document collaboration may be cumbersome, difficult, and inefficient, ultimately resulting in a lack of participating in document collaboration.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In summary, the disclosure generally relates to systems and methods for providing contact suggestions. In one aspect, rendering of a file created with an application in a user interface may be initiated. The file may include at least one collaboration feature. In response to receiving an indication of interest made with respect to the at least one collaboration feature, a plurality of contacts and an associated relevancy score for each of the plurality of contacts may be received. The plurality of contacts may be sorted by the associated relevancy score for each of the plurality of contacts. At least some of the plurality of contacts may be displayed within a picker displayed on the user interface based on the associated relevancy score.

In another aspect, data associated with a file created with an application may be received. The data may include at least a set of contacts and one or more contextual features associated with a user of the file. A relevancy score for each contact of the set of contacts may be determined based on at least one of the one or more contextual features associated with the user of the file. Updated data including at least one or more updated contextual features associated with the user of the file may be received. In response to receiving the updated data, the relevancy score for at least some contacts of the set of contacts may be modified based on the at least one or more updated contextual features associated with the user of the file.

In yet another aspect, a collaboration application comprises a file in a user interface for collaborating among a plurality of collaborators of the file. The collaboration application may further comprise at least one collaboration feature in the user interface through which to receive an indication of interest made with respect to the at least one collaboration feature. The collaboration application may further comprise a picker in the user interface through which, in response to the indication of interest made with respect to the collaboration feature, at least some of a plurality of contacts are displayed based on a relevancy score.

### DESCRIPTION OF THE DRAWINGS

The detailed description is made with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an exemplary file collaboration system for providing dynamic contact suggestions, according to an example aspect.

FIG. 2A illustrates one view in a progression of views a word processing application displayed on a user interface of a client computing device, according to an example aspect.

FIG. 2B illustrates another view in a progression of views of the word processing application of FIG. 2A, according to an example aspect.

FIG. 3 illustrates one view of a word processing application displayed on a user interface of a client computing device, according to an example aspect.

FIG. 4 illustrates one view of a word processing application displayed on a user interface of a client computing device, according to an example aspect.

FIG. 5 illustrates an exemplary method for providing dynamic contact suggestions, according to an example aspect.

FIG. 6 illustrates a computing system suitable for implementing the enhanced collaboration technology disclosed herein, including any of the environments, architectures, elements, processes, user interfaces, and operational scenarios and sequences illustrated in the Figures and discussed below in the Technical Disclosure.

### DETAILED DESCRIPTION

Aspects of the disclosure are generally directed to providing contact suggestions. For example, a file such as a word processing file created by a collaboration application may include one or more collaboration features such as sharing the file and an @mention feature. The one or more collaboration features of the file may be used to facilitate collaborating and/or co-authoring between a user and the co-authors/collaborators of the file. For example, a user of the file may want to quickly share the file with a collaborator and/or @mention another user/collaborator while providing a comment, for example. In this regard, when a user is selecting and/or searching for another user to share the file with, contact suggestions may be provided dynamically based on contextual features associated with the user of the file and/or the file itself. For example, contact suggestions may be provided based on one or more activities associated with the user who wants to share the file, file content, and/or a file storage location. As such, the user may quickly and efficiently identify one or more users with whom they want to share their file without spending time typing in the full name of another user, for example.

As discussed above, current techniques for identifying other users to collaborate with requires typing in the name of other potential users and selecting their name when they have been suggested and identified. As such, identifying users for document collaboration may be cumbersome, difficult, and inefficient, ultimately resulting in a lack of participating in document collaboration. Accordingly, aspects described herein include techniques that make sharing a file and/or @mentioning another user/collaborator of the file intuitive, user-friendly, and efficient. For example, by dynamically suggesting contacts to share the file with, a user can quickly select a contact from her most relevant contacts without having to go through the picking experience. In some cases, contact photos may be presented within the file providing a reminder for the user of the file to invite relevant contacts to collaborate in the file.

In one aspect, rendering of a file created with an application in a user interface may be initiated. The file may include at least one collaboration feature. In one example, the at least one collaboration feature is sharing the file. In another example, the at least one collaboration feature is an @mention feature. Data associated with the file may be sent to a service (e.g., a server computing device). For example, the data may include at least a set of contacts and one or more contextual features associated with a user of the file. A relevancy score for each contact of the set of contacts may be determined based on at least one of the one or more contextual features associated with the user of the file. In one example, the relevancy score is determined at the service. In another example, the relevancy score is determined by a Find People Application Programming Interface (API).

In some examples, updated data including at least one or more updated contextual features associated with the user of the file may be sent to and received by the service. In response to receiving the updated data, the relevancy score for at least some contacts of the set of contacts may be modified based on the at least one or more updated contextual features associated with the user of the file. In response to receiving an indication of interest made with respect to the at least one collaboration feature of the file, a plurality of contacts and an associated relevancy score for each of the plurality of contacts may be received. For example, the determined relevancy score and/or modified relevancy score may be sent from the service to a client computing device associated with a user of the file. In some cases, the plurality of contacts may be sorted by the associated relevancy score for each of the plurality of contacts. At least some of the plurality of contacts may be displayed within a picker displayed on the user interface based on the relevancy score. In this regard, a user may quickly, intuitively, and efficiently identify and select relevant contacts to share a file with, for example, while collaborating within applications.

As such, a technical effect that may be appreciated is that at least some of a plurality of contacts may be displayed within a picker displayed in a user interface based on a relevancy score in a clear and understandable manner and on a functional surface. In turn, collaboration on documents may be accomplished in a faster and/or more efficient manner, ultimately reducing processor load, conserving memory, and reducing network bandwidth usage. Another technical effect that may be appreciated is that users and/or co-authors/collaborators of a file may quickly, easily, and efficiently view and select those contacts that are most relevant to them for sharing a file and/or @mentioning a contact while collaborating within applications. Yet another technical effect that may be appreciated is that displaying at least some of a plurality of contacts within a picker displayed in a user interface based on a relevancy score facilitates a compelling visual and functional experience to allow a user to efficiently interact with a user interface for collaborating and/or co-authoring within applications.

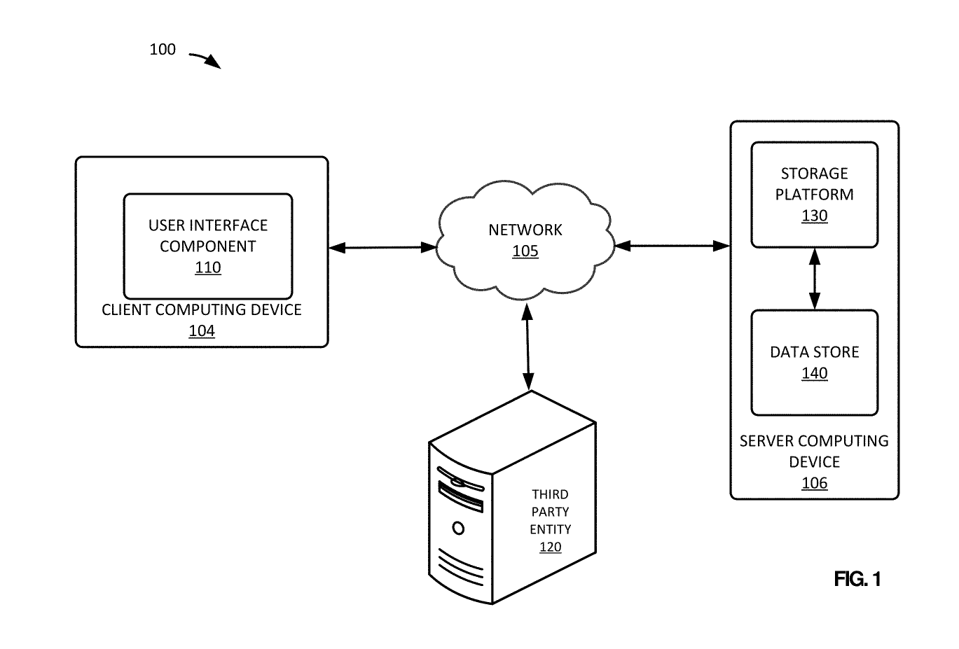

Referring now to the drawings, in which like numerals represent like elements through the several figures, aspects of the present disclosure and the exemplary operating environment will be described. With reference to FIG. 1, one aspect of a file collaboration system 100 for providing dynamic contact suggestions is illustrated. The file collaboration system 100 may include a client computing device 104, a server computing device 106, and a third party entity 120. In aspects, the file collaboration system 100 may be implemented on the client computing device 104. In a basic configuration, the client computing device 104 is a handheld computer having both input elements and output elements. The client computing device 104 may be any suitable computing device for implementing the file collaboration system 100 for providing dynamic contact suggestions. For example, the client computing device 104 may be at least one of: a mobile telephone; a smart phone; a tablet; a phablet; a smart watch; a wearable computer; a personal computer; a desktop computer; a laptop computer; a gaming device/computer (e.g., Xbox); a television; and etc. This list is exemplary only and should not be considered as limiting. Any suitable client computing device 104 for implementing the file collaboration system 100 for providing dynamic contact suggestions may be utilized.

In aspects, the file collaboration system 100 may be implemented on the server computing device 106. The server computing device 106 may provide data to and from the client computing device 104 through a network 105. In aspects, the file collaboration system 100 may be implemented on more than one server computing device 106, such as a plurality of server computing devices 106. As discussed above, the server computing device 106 may provide data to and from the client computing device 104 through the network 105. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval, and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As discussed above, the file collaboration system 100 may include the client computing device 104, the server computing device 106, and the third party entity 120. In aspects, the third party entity 120 may provide data to and from the client computing device 104 and/or the server computing device 106 through the network 105. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums. In some cases, the third party entity 120 may include any entity capable of providing a cloud connected storage platform for storing contact information. For example, the third party entity 120 may include entities such as social media, academics and/or universities, file/document processing tools, content reading and/or converting software, and the like. It is appreciated that while the file collaboration system 100 illustrates the third party entity 120, any number of third party entities may be implemented within the file collaboration system 100.

The various components may be implemented using hardware, software, or a combination of hardware and software. In aspects, the client computing device 104 may include a user interface component 110. The user interface component 110 may facilitate providing dynamic contact suggestions. For example, the user interface component 110 may initiate rendering of a file created with an application in a user interface of the client computing device 104. In one example, an application may include any application suitable for collaboration and/or co-authoring such as a word processing application, spreadsheet application, electronic slide presentation application, email application, chat application, voice application, and the like. In one case, a file associated with and/or created with the application may include a word document, a spreadsheet, an electronic slide presentation, an email, a chat conversation, and the like. As such, an exemplary application may be an electronic slide presentation application. In this example, an exemplary file associated with the electronic slide presentation application may include an electronic slide presentation.

In another example, the file may include at least one collaboration feature. In one example, the at least one collaboration feature may include sharing the file. For example, a list including one or more contacts associated with a user of the file may be presented in response to receiving an indication of interest made with respect to a share icon. In another example, a list including one or more contacts associated with a user of the file may be presented in response to receiving an indication of interest made with respect to a share pane. In one example, the share pane includes a photo and name of the most relevant contacts associated with a user of the file. In some cases, the list is presented within a picker displayed in the user interface of the client computing device 104. In this regard, a user may select at least one contact with whom to share the file. In another example, a list including one or more contacts associated with a user of the file may be presented at any time while the user is within the file. In one example, a list including one or more contacts associated with a user of the file may be presented within the file after a user adds content to the file and saves the file. In another example, the at least one collaboration feature may be an @mention feature. For example, a user may comment on content drafted by a first co-author, e.g., via a direct mention of the first co-author in the comment using an @mention (e.g., @ the first co-author's name). In another example, a first co-author may mention the user's name, e.g., via a direct mention of the user using an @mention (e.g., @ the user's name). In this regard, when a user and/or co-author of a file uses the @mention collaboration feature, a picker including relevant contacts associated with the user and/or co-author (e.g., contacts based on a relevancy score) may be displayed proximal the @mention within the file.

In one aspect, in response to receiving an indication of interest made with respect to the at least one collaboration feature, the client computing device 104 may receive a plurality of contacts and an associated relevancy score for each of the plurality of contacts. In one example, an indication of interest may include touching, clicking on, audibly referencing, pointing to, selecting, and/or any indication of an interest in or selection of the at least one collaboration feature. In one example, the plurality of contacts are associated with the user of the file. In one case, the associated relevancy score for each of the plurality of contacts is based on contextual features associated with the user of the file such as one or more activities associated with a user of the file. In one example, the one or more activities associated with the user of the file may include content changes, communication activities, document content exchanges, permission requests, sharing, printing, and the like. For example, communication activities may include email communications and the associated relevancy score may be based on the contacts the user sends emails to and the contacts the user receives emails from. In another example, an activity may include meetings the user has with contacts and the contacts who the user has meetings with may be used to determine the associated relevancy score of a contact. The sharing activity may include the contacts the user has previously shared files with, the contacts the user commonly shares files with, the contacts who share files with the user, and the like. In this regard, the associated relevancy score may be based on contacts the user shares files with, how often the user shares files with a contact, and/or contacts who share files with the user and/or how often contacts share files with the user. In one example, the associated relevancy score may be based on other contacts with whom a file has been shared. For example, when a user shares a file with five contacts in a group project, for example, and forgets to share the file with a sixth contact in the group project, the sixth contact may be assigned a high relevancy score.

In another case, the associated relevancy score for each of the plurality of contacts is based on a file storage location. For example, the applications and/or files created with the applications may be accessed and/or stored based on an account associated with a user. In one example, shareable files may be stored on consumer and/or business accounts associated with the user. For example, a user's consumer account may be associated with a cloud storage service such as OneDrive. In another example, a user's business account may be associated with a cloud storage service such as SharePoint. In this regard, when a user is using her consumer account while collaborating within an application and/or file, the associated relevancy score for each of the plurality of contacts associated with the user's consumer account may be assigned a higher relevancy score than each of the plurality of contacts associated with the user's business account, for example.

In another case, the associated relevancy score for each of the plurality of contacts is based on file content. For example, the file content may include a file type, title, and/or keywords. In this regard, the associated relevancy score may be determined by associating files with similar titles, similar file types, and/or similar keywords with the contacts with whom these files are shared. For example, a file with a title that is similar to titles of files that are consistently shared with a particular group of contacts may be associated with this particular group of contacts. In this example, the associated relevancy score may be high for this particular group of contacts. In another example, a file with keywords related to a topic may be associated with a group of contacts with whom previous files having keywords related to that topic have been shared. In this example, the associated relevancy score may be high for the group of contacts with whom previous files having keywords related to that topic have been shared.

In one aspect, the associated relevancy score for each of the plurality of contacts is based on any of the contextual features described herein and/or any combination of the contextual features described herein. For example, a relevancy score may be determined for each of a plurality of contacts based on any combination of contextual features associated with the user of the file such as one or more activities associated with a user of the file, file content, a file storage location, and/or collaboration features (e.g., sharing the file and/or the @mention feature).

In one aspect, the user interface component 110 may sort the plurality of contacts by the associated relevancy score for each of the plurality of contacts. For example, the user interface component 110 may sort the plurality contacts from a highest relevancy score to a lowest relevancy score. In another example, the user interface component 110 may sort the plurality of contacts from a lowest relevancy score to a highest relevancy score. In some cases, a number of contacts having the highest relevancy score may be suggested to a user for collaborating within a file. For example, at least some of the contacts having a highest relevancy score may be suggested for sharing the file. In another example, at least some of the contacts having a highest relevancy score may be suggested when a user inputs a @mention in the file. Any number of contacts may be suggested to a user for collaborating within a file. For example, the five contacts having the highest relevancy score may be suggested to a user for collaborating within a file.

In another aspect, the user interface component 110 and/or the file rendered on the user interface may display at least some of the plurality of contacts within a picker displayed in the user interface based on the relevancy score. For example, any number of contacts having a high and/or highest relevancy score may be displayed within the picker displayed in the user interface. In one example, the picker is displayed in the user interface within the share pane. In another example, the picker is displayed in the user interface proximal to the file content. In one case, the user interface component 110 may modify at least some of the plurality of contacts displayed within the picker. For example, when the associated relevancy score for at least some of the plurality of contacts changes, the user interface component 110 may modify at least some of the plurality of contacts displayed within the picker based on the changes in the associated relevancy score. In one case, the contacts having a higher associated relevancy score after the change, may replace (e.g., may be displayed within the picker) at least some contacts having a lower associated relevancy score after the change.

In one example, the user interface component 110 may be a touchable user interface that is capable of receiving input via contact with a screen of the client computing device 104, thereby functioning as both an input device and an output device. For example, content may be displayed, or output, on the screen of the client computing device 104 and input may be received by contacting the screen using a stylus or by direct physical contact of a user, e.g., touching the screen. Contact may include, for instance, tapping the screen, using gestures such as swiping or pinching the screen, sketching on the screen, etc.

In another example, the user interface component 110 may be a non-touch user interface. In one case, a tablet device, for example, may be utilized as a non-touch device when it is docked at a docking station (e.g., the tablet device may include a non-touch user interface). In another case, a desktop computer may include a non-touch user interface. In this example, the non-touchable user interface may be capable of receiving input via contact with a screen of the client computing device 104, thereby functioning as both an input device and an output device. For example, content may be displayed, or output, on the screen of the client computing device 104 and input may be received by contacting the screen using a cursor, for example. In this regard, contact may include, for example, placing a cursor on the non-touchable user interface using a device such as a mouse.

In some aspects, the server computing device 106 may include a storage platform 130 and the data store 140. In one example, the storage platform 130 may be configured to store, manage, and access data and/or information associated with the file collaboration system 100. For example, the storage platform 130 may store one or more files, one or more activities associated with a file, and/or one or more contacts associated with a user of the file in a data store 140. In another example, the storage platform 130 may receive data associated with a file created with an application. For example, the client computing device 104 may provide data to and from the server computing device 106 through the network 105. In some examples, the data may include at least a set of contacts and one or more contextual features associated with a user of the file. The one or more contextual features may include at least one or more activities associated with the user of the file, file content, and a file storage location, as discussed herein. The storage platform 130 may determine a relevancy score for each contact of the set of contacts based on at least one of the one or more contextual features associated with the user of the file, as discussed herein. In one case, the relevancy score for each contact of the set of contacts may be determined using a combination of the one or more contextual features. In some examples, the storage platform 130 may receive updated data including at least one or more updated contextual features associated with the user of the file. In response to receiving the updated data, the relevancy score for at least some contacts of the set of contacts may be modified based on the at least one or more updated contextual features associated with the user of the file. In some cases, the storage platform 130 may provide the set of contacts and the determined relevancy score for each contact of the plurality of contacts to the client computing device 104 associated with the user of the file. In some examples, the set of contacts and the determined relevancy score for each contact of the plurality of contacts is provided in response to an indication of interest made with respect to a collaboration feature of the file (e.g., in the user interface of the client computing device 104). As discussed herein, the collaboration feature of the file may include at least one of sharing the file and an @mention. In some cases, the relevancy score is determined based on identifying those contacts with whom the file has been shared.

In aspects, the data store 140 may be part of and/or located at the storage platform 130. In another example, data store 140 may be a separate component and/or may be located separate from the storage platform 130. It is appreciated that although one server computing device 106 is illustrated in FIG. 1, the file collaboration system 100 may include a plurality of server computing devices 106 with a plurality of storage platforms 130 and a plurality of data stores 140. In some cases, the server computing device 106 may include a plurality of storage platforms 130 and a plurality of data stores 140. For example, the plurality of storage platforms 130 may include at least file storage providers, external activity services and document editing clients. In one example, the storage platform 130 may be a cloud storage service such as OneDrive, SharePoint, Google Drive, Dropbox, and the like.

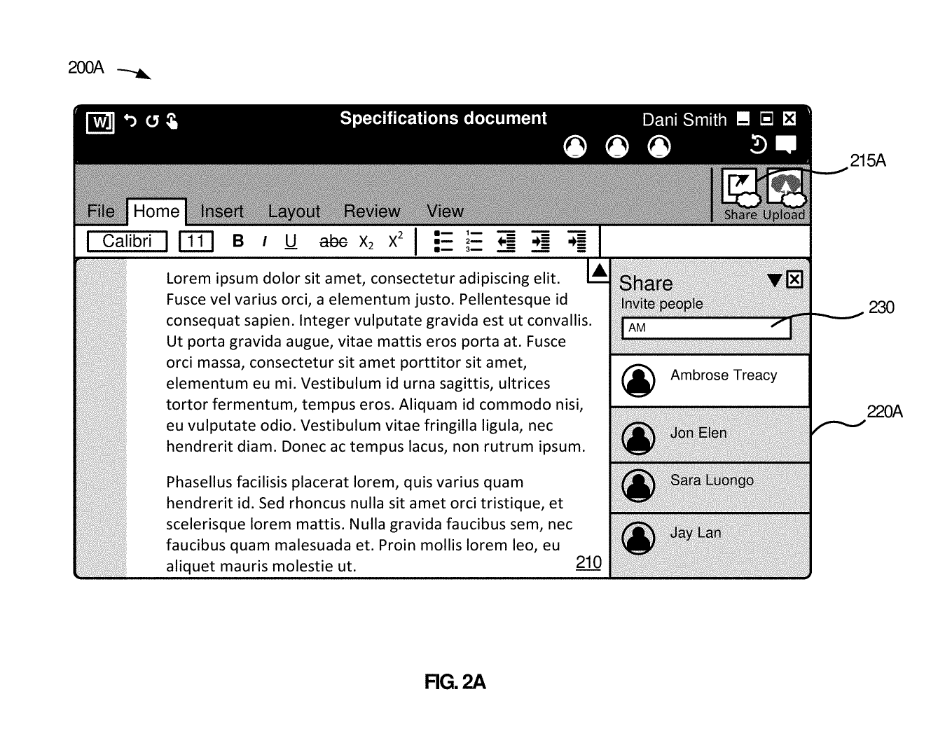

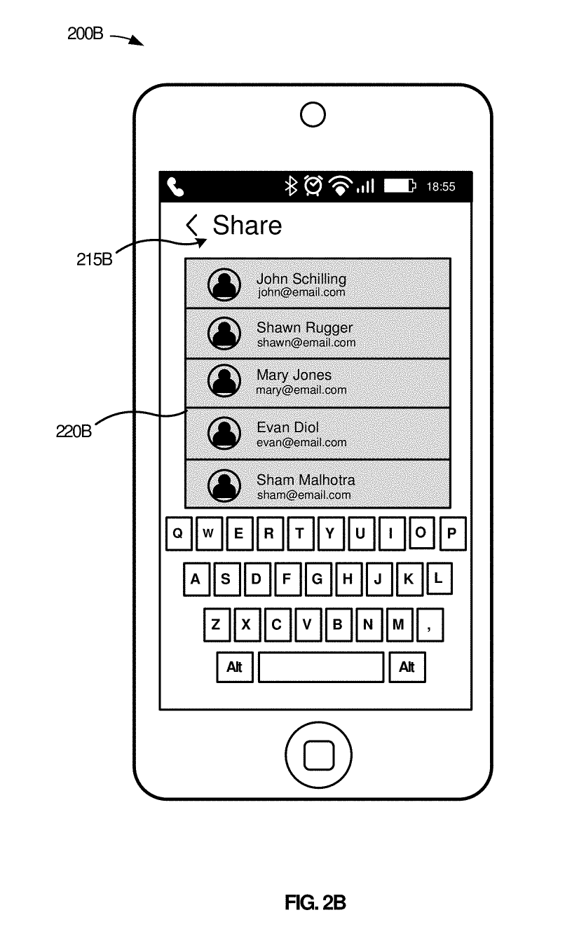

Referring now to FIG. 2A, one view 200A in a progression of views of a word processing application displayed on a user interface of the client computing device 104, such as a desktop computer, tablet computer or a mobile phone, for example, is shown. The exemplary application, as shown in FIG. 2A, is a word processing application. In one example, an application may include any information processing application suitable for collaboration and/or co-authoring such as a word processing application, spreadsheet application, and electronic slide presentation application. In one case, a file associated with the application may include a word document, a spreadsheet, and/or an electronic slide presentation. As such, an exemplary application may be a word processing application, as illustrated in FIG. 2A. In this example, an exemplary file associated with the word processing application may include a word document.

As illustrated, the exemplary view 200A of the word processing application displayed on the client computing device 104 includes a file 210, a collaboration feature 215A, a picker 220A, and an invite box 230. The collaboration feature 220A illustrated in FIG. 2A is a share icon. In one example, in response to receiving an indication of interest made with respect to the collaboration feature 215A, a plurality of contacts and an associated relevancy score for each of the plurality of contacts may be received. In one example, an indication of interest may include touching, clicking on, audibly referencing, pointing to, selecting, and/or any indication of an interest in or selection of the collaboration feature 215A. As illustrated in FIG. 2A, when the plurality of contacts and the associated relevancy score for each contact is received, at least some of the plurality of contacts may be displayed within the picker 220A based on the associated relevancy score. In the example illustrated in FIG. 2A, four contacts are displayed. In this case, the four contacts displayed within the picker 220A have the highest relevancy score of the plurality of contacts received. In another example, in response to receiving an indication of interest made with respect to the invite box 230, a plurality of contacts and an associated relevancy score for each of the plurality of contacts may be received. For example, when a user begins to type in the name of a contact (e.g., in this example “AM”), a plurality of contacts and an associated relevancy score for each of the plurality of contacts may be received. In response to receiving the plurality of contacts and the associated relevancy score for each contact of the plurality of contacts, at least some of the contacts may be displayed within the picker 220A based on the associated relevancy scores.

Referring now to FIG. 2B, one view 200B in a progression of views of a word processing application displayed on a user interface of the client computing device 104, such as a desktop computer, tablet computer or a mobile phone, for example, is shown. The exemplary application, as shown in FIG. 2B, is a word processing application. The exemplary client computing device 104, as shown in FIG. 2B, is a mobile phone. As illustrated, the exemplary view 200B of the word processing application displayed on the client computing device 104 includes a collaboration feature 215B and a picker 220B. The collaboration feature 215B illustrated in FIG. 2B is a share icon. In this regard, in response to receiving an indication of interest made with respect to the collaboration feature 215B, a plurality of contacts and an associated relevancy score for each of the plurality of contacts may be received. In one example, an indication of interest may include touching, clicking on, audibly referencing, pointing to, selecting, and/or any indication of an interest in or selection of the collaboration feature 215B. As illustrated in FIG. 2B, when the plurality of contacts and the associated relevancy score for each contact is received, at least some of the plurality of contacts may be displayed within the picker 220B based on the associated relevancy score. In the example illustrated in FIG. 2B, five contacts are displayed. In this case, the five contacts displayed within the picker 220B have the highest relevancy score of the plurality of contacts received.

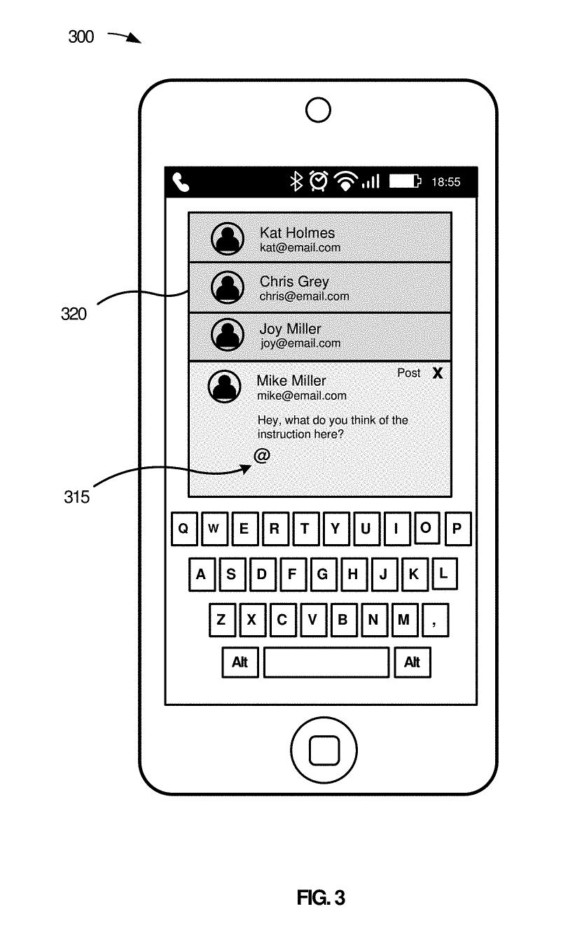

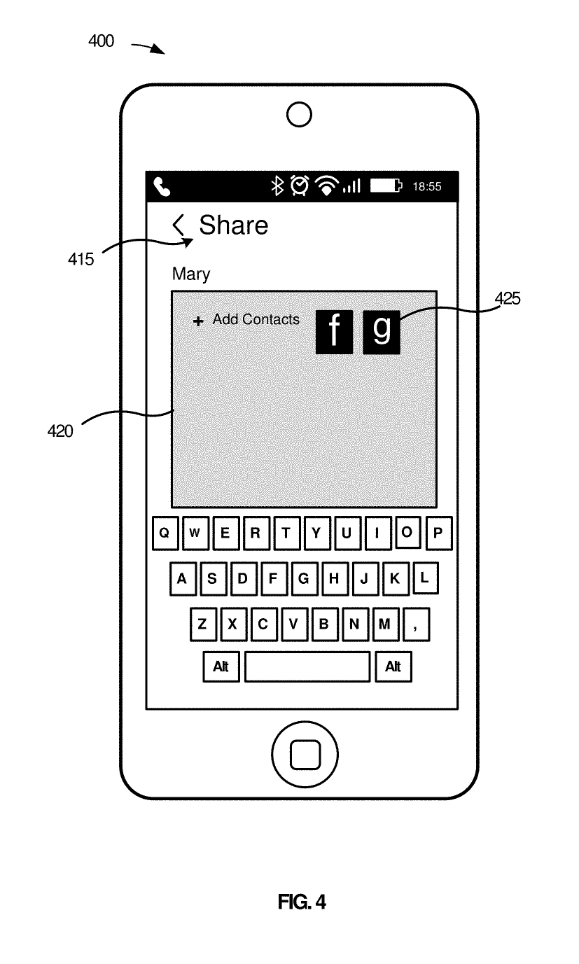

FIG. 3 illustrates one view 300 of a word processing application displayed on a user interface of the client computing device 104, such as a desktop computer, tablet computer or a mobile phone, for example, is shown. The exemplary application, as shown in FIG. 4, is a word processing application. As illustrated, the exemplary view 300 of the word processing application displayed on the client computing device 104 includes a collaboration feature 315 and a picker 320. The collaboration feature 315 illustrated in FIG. 3 is an @mention. In one example, in response to receiving an indication of interest made with respect to the collaboration feature 315, a plurality of contacts and an associated relevancy score for each of the plurality of contacts may be received. In one example, an indication of interest may include touching, clicking on, audibly referencing, pointing to, selecting, and/or any indication of an interest in or selection of the collaboration feature 315. In another example, an indication of interest may include typing the @ symbol within the file. As illustrated in FIG. 3, when the plurality of contacts and the associated relevancy score for each contact is received, at least some of the plurality of contacts may be displayed within the picker 320 based on the associated relevancy score. In the example illustrated in FIG. 3, three contacts are displayed. In this case, the three contacts displayed within the picker 320 have the highest relevancy score of the plurality of contacts received. In one case, the associated relevancy score when the collaboration feature 315 is @mention is determined based on the contacts with whom the file is shared. For example, a user may be more likely to @mention a contact with whom the file has been shared.

FIG. 4 illustrates one view 400 of a word processing application displayed on a user interface of the client computing device 104, such as a desktop computer, tablet computer or a mobile phone, for example, is shown. The exemplary application, as shown in FIG. 4, is a word processing application. As illustrated, the exemplary view 400 of the word processing application displayed on the client computing device 104 includes a collaboration feature 415, a picker 420, and a third party account link 425. The collaboration feature 415 illustrated in FIG. 4 is a share icon. In one example, in response to receiving an indication of interest made with respect to the collaboration feature 415, a plurality of contacts and an associated relevancy score for each of the plurality of contacts may be received. In one example, an indication of interest may include touching, clicking on, audibly referencing, pointing to, selecting, and/or any indication of an interest in or selection of the collaboration feature 415. In one case, the relevancy score may be low for each contact of the plurality of contacts received. In this example, the third party account link 425 may be suggested and displayed within the picker 420. In another case, in response to receiving an indication of interest made with respect to the collaboration feature 415, no contacts may be received. In this example, the third party account link 425 may be suggested and displayed within the picker 420. In one example, the third party account link 425 may include a social media and/or email account associated with a user of the file. For example, as illustrated in FIG. 4, the third party account link 425 may include a Facebook® account and/or Google® account associated with the user of the file. In this example, in response to receiving an indication of interest made with respect to the third party account link 425, contacts from the user's third party account may be added and/or linked to the current account the user is signed-in to (e.g., a consumer or business account associated with the word processing application displayed on a user interface of the client computing device 104).

It is appreciated that while FIGS. 2A-4 illustrate a word processing application, file 210, collaboration features 215A, 215B, 315, and 415, picker 220A, 220B, 320, and 420, and third party account link 425 of the word processing application, file 210, collaboration features 215A, 215B, 315, and 415, picker 220A, 220B, 320, and 420, and third party account link 425 is exemplary only and should not be considered as limiting. Any suitable number and/or type of applications, files, collaboration features, pickers, and third party account links may be utilized in conjunction with the present disclosure.

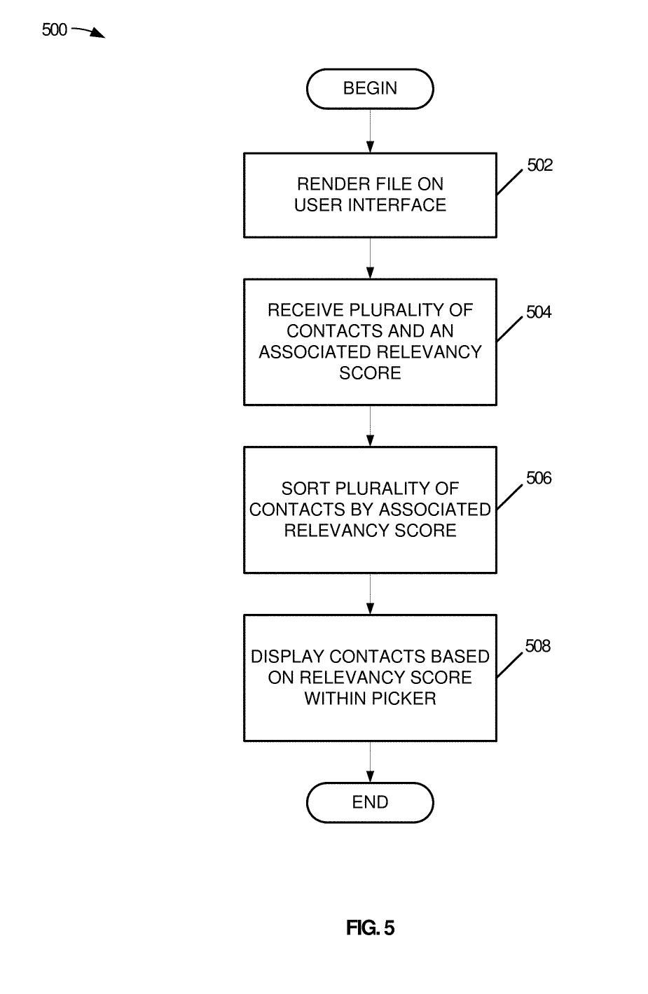

Referring now to FIG. 5, an exemplary method 500 for providing dynamic contact suggestions, according to an example aspect is shown. Method 500 may be implemented on a computing device or a similar electronic device capable of executing instructions through at least one processor. For example, the software application may be one of an email application, a social networking application, project management application, a collaboration application, an enterprise management application, a messaging application, a word processing application, a spreadsheet application, a database application, a presentation application, a contacts application, a calendaring application, etc. This list is exemplary only and should not be considered as limiting. Any suitable application for providing dynamic contact suggestions may be utilized by method 500, including combinations of the above-listed applications.

Method 500 may begin at operation 502, where rendering of a file created with an application on a user interface is initiated. In one example, the file may be rendered on a client computing device. In one example, an application may include any application suitable for collaboration and/or co-authoring such as a word processing application, spreadsheet application, electronic slide presentation application, email application, chat application, voice application, and the like. In one case, a file associated with and/or created with the application may include a word document, a spreadsheet, an electronic slide presentation, an email, a chat conversation, and the like. In one example, the file may include at least one collaboration feature. The at least one collaboration feature may include at least one of sharing the file and an @mention feature.

When the file created with an application is rendered on a user interface, flow proceeds to operation 504 where a plurality of contacts and an associated relevancy score for each of the plurality of contacts are received. In one example, the plurality of contacts and an associated relevancy score for each of the plurality of contacts are received in response to receiving an indication of interest with respect to the at least one collaboration feature. In one case, the associated relevancy score for each of the plurality of contacts is based on contextual features associated with the user of the file such as one or more activities associated with a user of the file. In another case, the associated relevancy score for each of the plurality of contacts is based on file content. In another case, the associated relevancy score for each of the plurality of contacts is based on a file storage location. In another case, the associated relevancy score for each of the plurality of contacts is based on a combination of any of the contextual features associated with the user of the file.

When the plurality of contacts and an associated relevancy score for each of the plurality of contacts are received, flow proceeds to operation 506 where the plurality of contacts are sorted by the associated relevancy score for each of the plurality of contacts. For example, the plurality contacts may be sorted from a highest relevancy score to a lowest relevancy score. In another example, the plurality of contacts may be sorted from a lowest relevancy score to a highest relevancy score. In some cases, a number of contacts having the highest relevancy score may be suggested to a user for collaborating within a file. For example, at least some of the contacts having a highest relevancy score may be suggested for sharing the file. In another example, at least some of the contacts having a highest relevancy score may be suggested when a user inputs an @mention in the file. Any number of contacts may be suggested to a user for collaborating within a file. For example, the ten contacts having the highest relevancy score may be suggested to a user for collaborating within a file. In one example, contacts with whom the file is already shared may be excluded from being suggested for collaborating within the file.

When the plurality of contacts are sorted by the associated relevancy score for each of the plurality of contacts, flow proceeds to operation 508 where at least some of the plurality of contacts are displayed within a picker displayed in the user interface based on the associated relevancy score. For example, any number of contacts having a high and/or highest relevancy score may be displayed within the picker displayed in the user interface. In one example, the picker is displayed in the user interface within the share pane. In another example, the picker is displayed in the user interface proximal the file content. In one case, at least some of the plurality of contacts displayed within the picker may be modified. For example, when the associated relevancy score for at least some of the plurality of contacts changes, at least some of the plurality of contacts displayed within the picker may be modified based on the changes in the associated relevancy score.

The term rendering as used herein generally refers to the various capabilities employed in various computing architectures to assemble information that can then be used by other capabilities to generate an image or images. Within the context of method 500, for example, rendering a file, for example, generally refers to assembling the information or data used to generate an image or images that together result in the file including collaboration features. Animation or other dynamics may also be used to achieve certain effects.

However, it may be appreciated that other perspectives on rendering may be considered within the scope of the present disclosure. For example, rendering as used herein may also, in some scenarios, be considered to refer to the various capabilities employed by various computing architectures to generate an image or images from information assembled for that purpose. With respect to the method 500, rendering a file may refer to generating an image or images, from information assembled for that purpose, that together result in the file, which can then be displayed.

It may also be appreciated that rendering in some scenarios may refer to a combination of the aforementioned possibilities. For example, rendering in some scenarios may refer to both assembling the information used to generate an image or images for a file and then generating the image or images of the file. In addition, a wide variety of other steps, processes, and stages may occur within the context of presenting views of an application, all of which may be considered part of presenting a view. Thus, yet one other variation on method 500 includes, but is not limited to, presenting a file on a user interface, receiving a plurality of contacts, sorting the plurality of contacts and presenting the contacts within a picker.

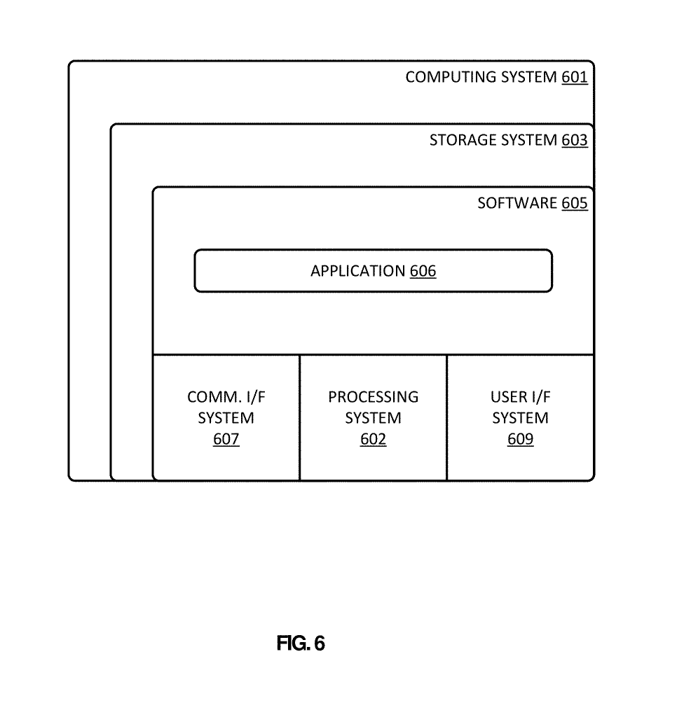

FIG. 6 illustrates computing system 601 that is representative of any system or collection of systems in which the various applications, services, scenarios, and processes disclosed herein may be implemented. Examples of computing system 601 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609. Processing system 602 is operatively coupled with storage system 603, communication interface system 607, and user interface system 609.

Processing system 602 loads and executes software 605 from storage system 603. Software 605 includes application 606, which is representative of the applications discussed with respect to the preceding FIGS. 1-5, including word processing applications described herein. When executed by processing system 602 to enhance collaboration, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device, but may also be distributed across multiple processing devices or sub-systems that cooperate in executing program instructions. Examples of processing system 602 include general purpose central processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device, but may also be implemented across multiple storage devices or sub-systems co-located or distributed relative to each other. Storage system 603 may comprise additional elements, such as a controller, capable of communicating with processing system 602 or possibly other systems.

Software 605 may be implemented in program instructions and among other functions may, when executed by processing system 602, direct processing system 602 to operate as described with respect to the various operational scenarios, sequences, and processes illustrated herein. For example, software 605 may include program instructions for implementing enhanced application collaboration.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtual machine software, or other application software, in addition to or that include application 606. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to facilitate enhanced application collaboration. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 609 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 609. In some cases, the input and output devices may be combined in a single device, such as a display capable of displaying images and receiving touch gestures. The aforementioned user input and output devices are well known in the art and need not be discussed at length here.

User interface system 609 may also include associated user interface software executable by processing system 602 in support of the various user input and output devices discussed above. Separately or in conjunction with each other and other hardware and software elements, the user interface software and user interface devices may support a graphical user interface, a natural user interface, or any other type of user interface.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Among other examples, the present disclosure presents systems comprising: one or more computer readable storage media; and program instructions stored on the one or more computer readable storage media that, when executed by at least one processor, cause the at least one processor to at least: receive data associated with a file created with an application, wherein the data includes at least a set of contacts and one or more contextual features associated with a user of the file; determine a relevancy score for each contact of the set of contacts based on at least one of the one or more contextual features associated with the user of the file; receive updated data including at least one or more updated contextual features associated with the user of the file; and in response to receiving the updated data, modify the relevancy score for at least some contacts of the set of contacts based on the at least one or more updated contextual features associated with the user of the file. In further examples, the one or more contextual features include at least one or more activities associated with the user of the file, file content, and a file storage location. In further examples, the program instructions, when executed by the at least one processor, further cause the at least one processor to determine the relevancy score for each contact of the set of contacts using a combination of the one or more contextual features. In further examples, the program instructions, when executed by the at least one processor, further cause the at least one processor to provide the set of contacts and the determined relevancy score for each contact of the plurality of contacts to a client computing device associated with the user of the file. In further examples, the set of contacts and the determined relevancy score for each contact of the plurality of contacts is provided in response to an indication of interest made with respect to a collaboration feature of the file. In further examples, the collaboration feature of the file includes at least one of sharing the file and a @mention. In further examples, the relevancy score is determined based on identifying those contacts with whom the file has been shared. In further examples, the file storage location is associated with an account of the user of the file.

Further aspects disclosed herein provide an exemplary method for providing dynamic contact suggestions, the method comprising: initiating rendering of a file created with an application in a user interface, the file including at least one collaboration feature; in response to receiving an indication of interest made with respect to the at least one collaboration feature, receiving a plurality of contacts and an associated relevancy score for each of the plurality of contacts; sorting the plurality of contacts by the associated relevancy score for each of the plurality of contacts; and displaying at least some of the plurality of contacts within a picker displayed in the user interface based on the associated relevancy score. In further examples, the at least one collaboration feature is sharing the file. In further examples, the at least one collaboration feature is a @mention. In further examples, the associated relevancy score is based on one or more activities associated with a user of the file. In further examples, the associated relevancy score is based on a file storage location. In further examples, the associated relevancy score is based on file content. In further examples, the computer-implemented method further comprises suggesting a third party account link. In further examples, the computer-implemented method further comprises modifying at least some of the plurality of contacts displayed within the picker when the associated relevancy score for at least some of the plurality of contacts changes.

Additional aspects disclosed herein provide an exemplary computing apparatus comprising: one or more computer readable storage media; and a collaboration application embodied at least in part in program instructions stored on the one or more computer readable storage media and comprising: a file in a user interface for collaborating among a plurality of collaborators of the file; at least one collaboration feature in the user interface through which to receive an indication of interest made with respect to the at least one collaboration feature; and a picker in the user interface through which to, in response to the indication of interest made with respect to the collaboration feature, display at least some of a plurality of contacts based on a relevancy score. In further examples, the relevancy score is based on the at least one collaboration feature. In further examples, the at least one collaboration feature is at least one of sharing the file and a @mention. In further examples, the relevancy score is based on a combination of one or more activities associated with a user of the file, a file storage location, and file content.

Techniques for providing dynamic contact suggestions are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of collaboration systems that execute in conjunction with an application program that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A system comprising:
one or more computer readable storage media; and
program instructions stored on the one or more computer readable storage media that, when executed by at least one processor, cause the at least one processor to at least:
receive data associated with a file created with an application, wherein the data includes at least a set of contacts and one or more contextual features associated with a user of the file;
determine a relevancy score for each contact of the set of contacts based on at least one of the one or more contextual features associated with the user of the file;
receive updated data including at least one or more updated contextual features associated with the user of the file; and
in response to receiving the updated data, modify the relevancy score for at least some contacts of the set of contacts based on the at least one or more updated contextual features associated with the user of the file.

2. The system of claim 1, wherein the one or more contextual features include at least one or more activities associated with the user of the file, file content, and a file storage location.

3. The system of claim 2, wherein the program instructions, when executed by the at least one processor, further cause the at least one processor to determine the relevancy score for each contact of the set of contacts using a combination of the one or more contextual features.

4. The system of claim 1, wherein the program instructions, when executed by the at least one processor, further cause the at least one processor to provide the set of contacts and the determined relevancy score for each contact of the plurality of contacts to a client computing device associated with the user of the file.

5. The system of claim 4, wherein the set of contacts and the determined relevancy score for each contact of the plurality of contacts is provided in response to an indication of interest made with respect to a collaboration feature of the file.

6. The system of claim 5, wherein the collaboration feature of the file includes at least one of sharing the file and an @mention.

7. The system of claim 1, wherein the relevancy score is determined based on identifying those contacts with whom the file has been shared.

8. The system of claim 2, wherein the file storage location is associated with an account of the user of the file.

9. A computer-implemented method for providing dynamic contact suggestions, the method comprising:
initiating rendering of a file created with an application in a user interface, the file including at least one collaboration feature;
in response to receiving an indication of interest made with respect to the at least one collaboration feature, receiving a plurality of contacts and an associated relevancy score for each of the plurality of contacts;
sorting the plurality of contacts by the associated relevancy score for each of the plurality of contacts; and
displaying at least some of the plurality of contacts within a picker displayed in the user interface based on the associated relevancy score.

10. The computer-implemented method of claim 9, wherein the at least one collaboration feature is sharing the file.

11. The computer-implemented method of claim 9, wherein the at least one collaboration feature is an @mention.

12. The computer-implemented method of claim 9, wherein the associated relevancy score is based on one or more activities associated with a user of the file.

13. The computer-implemented method of claim 9, wherein the associated relevancy score is based on a file storage location.

14. The computer-implemented method of claim 9, wherein the associated relevancy score is based on file content.

15. The computer-implemented method of claim 9, further comprising suggesting a third party account link.

16. The computer-implemented method of claim 9, further comprising modifying at least some of the plurality of contacts displayed within the picker when the associated relevancy score for at least some of the plurality of contacts changes.

17. A computing apparatus comprising:
one or more computer readable storage media; and
a collaboration application embodied at least in part in program instructions stored on the one or more computer readable storage media and comprising:
a file in a user interface for collaborating among a plurality of collaborators of the file;
at least one collaboration feature in the user interface through which to receive an indication of interest made with respect to the at least one collaboration feature; and
a picker in the user interface through which to, in response to the indication of interest made with respect to the collaboration feature, display at least some of a plurality of contacts based on a relevancy score.

18. The computing apparatus of claim 17, wherein the relevancy score is based on the at least one collaboration feature.

19. The computing apparatus of claim 17, wherein the at least one collaboration feature is at least one of sharing the file and an @mention.

20. The computing apparatus of claim 17, wherein the relevancy score is based on a combination of one or more activities associated with a user of the file, a file storage location, and file content.
